(19) United States
(12) Patent Application Publication
(10) Pub. No.: US 2026/0074106 A1
(43) Pub. Date: Mar. 12, 2026

(54) TRANSFORMER STRUCTURE

(71) Applicant: Delta Electronics, Inc., Taoyuan City (TW)

(72) Inventors: Ruei-Wun JHONG, Taoyuan City (TW); Hung-Yu HUANG, Taoyuan City (TW); Qiang YAO, Taoyuan City (TW); Lei REN, Taoyuan City (TW)

(21) Appl. No.: 19/095,252

(22) Filed: Mar. 31, 2025

(30) Foreign Application Priority Data
Sep. 11, 2024 (CN) 202411272949.7

(51) Int. Cl. H01F 27/28; H01F 19/00; H01F 27/00; H01F 27/29

(52) U.S. Cl. CPC H01F 27/2828; H01F 27/006; H01F 27/292; H01F 19/00

(57) ABSTRACT

A transformer structure is provided. The transformer structure includes a core unit, a first winding, and a second winding. The first winding is disposed on the core unit and has a first low segment, a first high segment, and a first connecting portion connected between the first low segment and the first high segment. The second winding is accommodated in a gap formed between the first low segment and the first high segment.

### CROSS REFERENCE TO RELATED APPLICATIONS

This application claims the benefit of China patent application No. 202411272949.7, filed Sep. 11, 2024, the entirety of which is incorporated by reference herein.

### BACKGROUND OF THE INVENTION

### Field of the Invention

The present invention relates to a transformer structure, and, in particular, to a transformer structure with interleaved windings.

### Description of the Related Art

To connect the conventional interleaved windings of a transformer in series, both ends of the windings have to be mounted to the circuit board, and different windings can be electrically connected in series through the circuit board.

However, the conventional winding configuration may take up too much of the layout space on the circuit board, thus causing difficulties in circuit design and assembly. Moreover, the manufacturing cost may increase, and this is not conducive to the miniaturization of the product.

In view of this, how to design a transformer structure with interleaved windings and simplify the series connection of the windings becomes a challenge.

### BRIEF SUMMARY OF THE INVENTION

An embodiment of the present invention provides a transformer structure that includes a core unit, a first winding, and a second winding, wherein the core unit has a central axis. The first winding is disposed on the core unit and has a first low segment, a first high segment, and a first connecting portion connected between the first low segment and the first high segment, wherein a first gap is formed between the first low segment and the first high segment. The second winding is disposed on the core unit and having a second low segment, a second high segment, and a second connecting portion connected between the second low segment and the second high segment, wherein a second gap is formed between the second low segment and the second high segment. The second low segment is accommodated in the first gap, the first high segment is accommodated in the second gap, and the first low segment, the second low segment, the first high segment, and the second high segment are arranged along the central axis.

In some embodiments, the transformer structure is disposed on a substrate, and the first winding further has two first ends extending through the substrate and respectively connecting to the first low segment and the first high segment.

In some embodiments, the second winding further has two second ends extending through the substrate and respectively connecting to the second low segment and the second high segment, and the first and second ends are located on opposite sides of the core unit.

In some embodiments, the first connecting portion is folded around a horizontal axis that is perpendicular to the central axis.

In some embodiments, the first low winding segment, the first high winding segment, the second low winding segment and the second high winding segment have an oval structure, and a part of the core unit extends sequentially through the first low winding segment, the second low winding segment, the first high winding segment and the second high winding segment along the central axis.

In some embodiments, the first and second windings respectively comprise a flat copper wire that is integrally formed in one piece.

Another embodiment of the present invention provides a transformer structure that includes a core unit, a first winding, and a second winding, wherein the core unit has a central axis. The first winding is disposed on the core unit and has a first low segment, a first high segment, and a first connecting portion connected between the first low segment and the first high segment, wherein a gap is formed between the first low segment and the first high segment. The second winding, accommodated in the gap, wherein the first low segment, the second winding, and the first high segment are arranged along the central axis.

In some embodiments, the first low winding segment and the first high winding segment have a circular structure, and a part of the core unit extends sequentially through the first low winding segment, the second winding, and the first high winding segment along the central axis.

In some embodiments, the first connecting portion has a C-shaped structure, and the first winding comprises a flat copper wire that is integrally formed in one piece.

In some embodiments, the second winding comprises a multi-strand wire.

### BRIEF DESCRIPTION OF THE DRAWINGS

The present invention can be more fully understood by reading the subsequent detailed description and examples with references made to the accompanying drawings, wherein:

FIG. 1 shows a perspective diagram of a transformer structure 100 in accordance with an embodiment of the invention.

FIG. 2 shows another perspective diagram of the transformer structure 100 in FIG. 1.

FIG. 3 is an exploded view of the transformer structure 100 in FIGS. 1 and 2.

FIG. 4 shows a perspective diagram of the first winding C1 in FIGS. 1-3 before forming the C-shaped first connecting portion C13.

FIG. 5 is an exploded view of the winding C1 and the second winding C2 in FIGS. 1-3 before assembly.

FIG. 6 shows a perspective diagram of the first winding C1 and the second winding C2 in FIGS. 1-3 after assembly.

FIG. 7 is a perspective diagram of a transformer structure 200 in accordance with another embodiment of the invention.

FIG. 8 is an exploded view of the transformer structure 200 in FIG. 7.

FIG. 9 is a cross-sectional view of the transformer structure 200 in FIG. 7.

FIG. 10 is a perspective diagram of the first winding C1 in FIGS. 7-9 before forming the C-shaped first connecting portion C13.

FIG. 11 is a perspective diagram of the first winding C1 in FIG. 10 after forming the C-shaped first connecting portion C13.

FIG. 12 is another perspective diagram of the first winding C1 after forming the C-shaped first connecting portion C13.

### DETAILED DESCRIPTION OF THE INVENTION

The making and using of the embodiments of the transformer structure are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

In the following detailed description of the preferred embodiments, reference is made to the accompanying drawings, and in which specific embodiments of which the invention may be practiced are shown by way of illustration. In this regard, directional terminology, such as “top,” “bottom,” “left,” “right,” “front,” “back,” etc., is used with reference to the orientation of the figures being described. The components of the present invention can be positioned in a number of different orientations. As such, the directional terminology is used for the purposes of illustration and is in no way limiting.

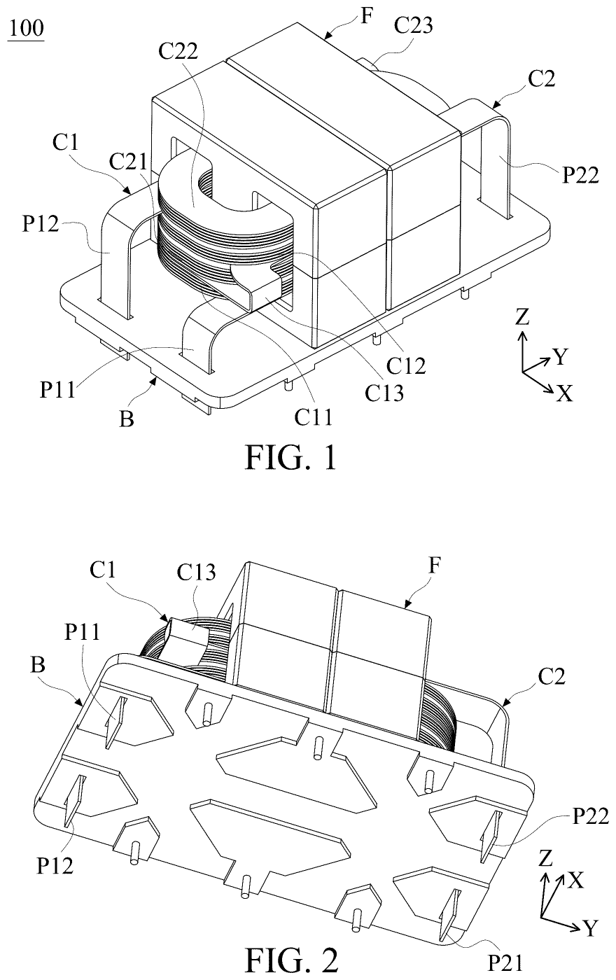

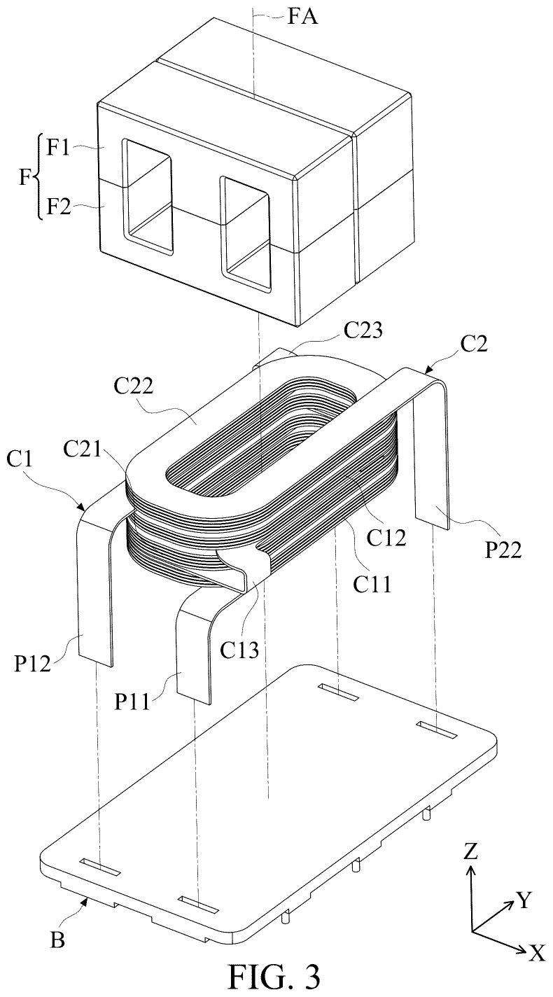

FIG. 1 shows a perspective diagram of a transformer structure 100 in accordance with an embodiment of the invention. FIG. 2 shows another perspective diagram of the transformer structure 100 in FIG. 1. FIG. 3 is an exploded view of the transformer structure 100 in FIGS. 1 and 2.

As shown in FIGS. 1, 2 and 3, the transformer structure 100 in this embodiment primarily includes a core unit F, a first winding C1 and a second winding C2. It should be noted that the transformer structure 100 is disposed on a substrate B and is provided with interleaved windings.

In this embodiment, the first winding C1 and the second winding C2 are made of flat copper wires, and the core unit F is formed by two E-shaped magnetic permeable members F1 and F2 (FIG. 3). During assembly, the middle portions of the magnetic permeable members F1 and F2 are inserted through the first winding C1 and the second winding C2. Moreover, the first ends P11 and P12 of the winding C1 and the second ends P21 and P22 of the second winding C2 penetrate through the substrate B, whereby the first winding C1 and the second winding C2 are firmly mounted on the substrate B.

It should be noted that the first ends P11 and P12 of the first winding C1 and the second ends P21 and P22 of the second winding C2 are located on opposite sides of the core unit F. Hence, the first winding C1 and the second winding C2 can be electrically connected to an external circuit (not shown) through the first ends P11 and P12 and the second ends P21 and P22, respectively.

Here, the first winding C1 and the second winding C2 are disposed around and coupled to the core unit F, wherein the first winding C1 has a first low winding segment C11, a first high winding segment C12, and a first connecting portion C13.

The first connecting portion C13 has a C-shaped structure for connecting the first low winding segment C11 to the first high winding segment C12. In this configuration, the first low winding segment C11 and the first high winding segment C12 are arranged along the central axis FA of the core unit F (FIG. 3), and at least a part of the second winding C2 is accommodated in the gap between the first low winding segment C11 and the first high winding segment C12 to form the interleaved winding structure.

Similarly, the second winding C2 has a second low winding segment C21, a second high winding segment C22 and a second connecting portion C23, wherein the second connecting portion C23 has a C-shaped structure for connecting the second low winding segment C21 to the second high winding segment C22.

Hence, the second low winding segment C21 and the second high winding segment C22 are arranged along the central axis FA of the core unit F (FIG. 3), and at least a part of the first winding C1 is accommodated in the gap between the first low winding segment C21 and the second high winding segment C22 to form the interleaved winding structure.

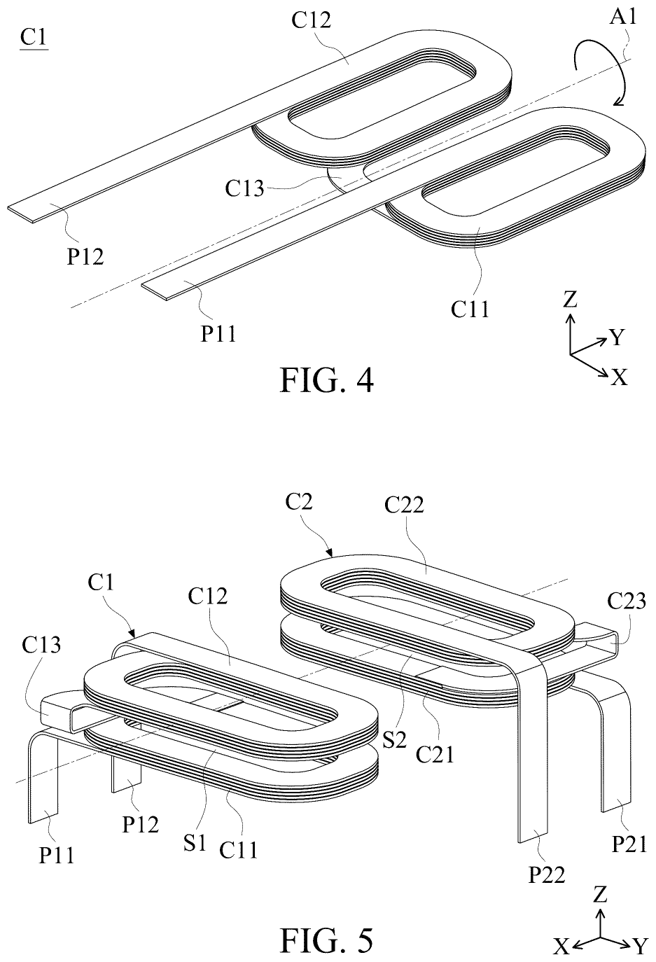

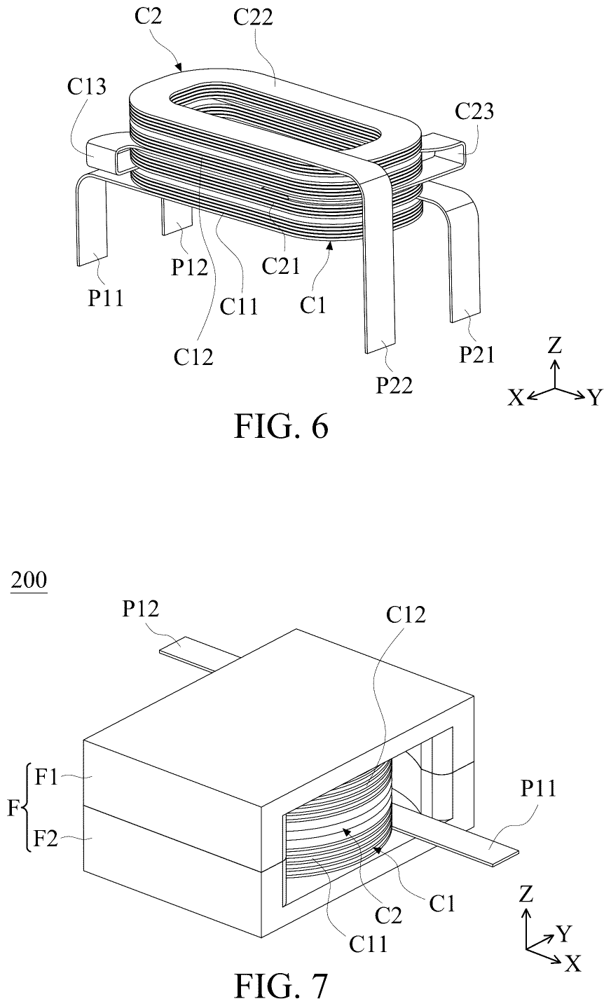

FIG. 4 shows a perspective diagram of the first winding C1 in FIGS. 1-3 before forming the C-shaped first connecting portion C13. FIG. 5 is an exploded view of the winding C1 and the second winding C2 in FIGS. 1-3 before assembly. FIG. 6 shows a perspective diagram of the first winding C1 and the second winding C2 in FIGS. 1-3 after assembly.

As shown in FIG. 4, the first winding C1 comprises a flat copper wire that is integrally formed in one piece. During assembly, the flat copper wire can be processed by a winding machine to form the first low winding segment C11 and the first high winding segment C12 that have a substantially elliptical structure. Subsequently, the first connecting portion C13 between the first low winding segment C11 and the first high winding segment C12 can be folded around the horizontal axis A1 as shown in FIG. 4, whereby the first connecting portion C13 forms a C-shaped structure (FIGS. 5 and 6).

In this configuration, the first low winding segment C11 and the first high winding segment C12 are arranged along the central axis FA of the core unit F (FIG. 3), and a first gap S1 is formed between the first low winding segment C11 and the first high winding segment C12, as shown in FIG. 5.

Similarly, the second winding C2 also comprises a flat copper wire that is integrally formed in one piece. During assembly, the flat copper wire can be processed by a winding machine to form the second low winding segment C21 and the second high winding segment C22 that have an oval structure. Subsequently, the second connecting portion C23 between the second low winding segment C21 and the second high winding segment C22 can be folded to form a C-shaped structure (FIGS. 5 and 6).

In this configuration, the second low winding segment C21 and the second high winding segment C22 are arranged along the central axis FA of the core unit F (FIG. 3), and a second gap S2 is formed between C21 and the second high winding segment C22, as shown in FIG. 5.

As can be seen from FIG. 6, the first winding C1 and the second winding C2 are interleaved with each other to form an interleaved winding structure, wherein the second low segment C21 of the second winding C2 is accommodated in the first gap S1 of the first winding C1, and the first high segment C12 is accommodated in the second gap S2 of the second winding C2.

It should be noted that the first low winding segment C11, the second low winding segment C21, the first high winding segment C12, and the second high winding segment C22 are arranged sequentially along the central axis FA of the core unit F (Z direction). Since the first low winding segment C11 and the first high winding segment C12 are connected in series through the C-shaped first connecting portion C13, they can be electrically connected to the external circuit through the first ends P11 and P12 of the first winding C1, thus reducing the number of contacts between the first winding C1 and the substrate B. Hence, assembly cost of the transformer structure 100 can be reduced, and miniaturization of the product can be also achieved.

Similarly, since the second low winding segment C21 and the second high winding segment C22 are connected in series via the second connecting portion C23, they can be electrically connected to the external circuit through the second ends P21 and P22 of the second winding C2, thus reducing the number of contacts between the second winding C2 and the substrate B. Hence, assembly cost of the transformer structure 100 can be reduced, and miniaturization of the product can be also achieved.

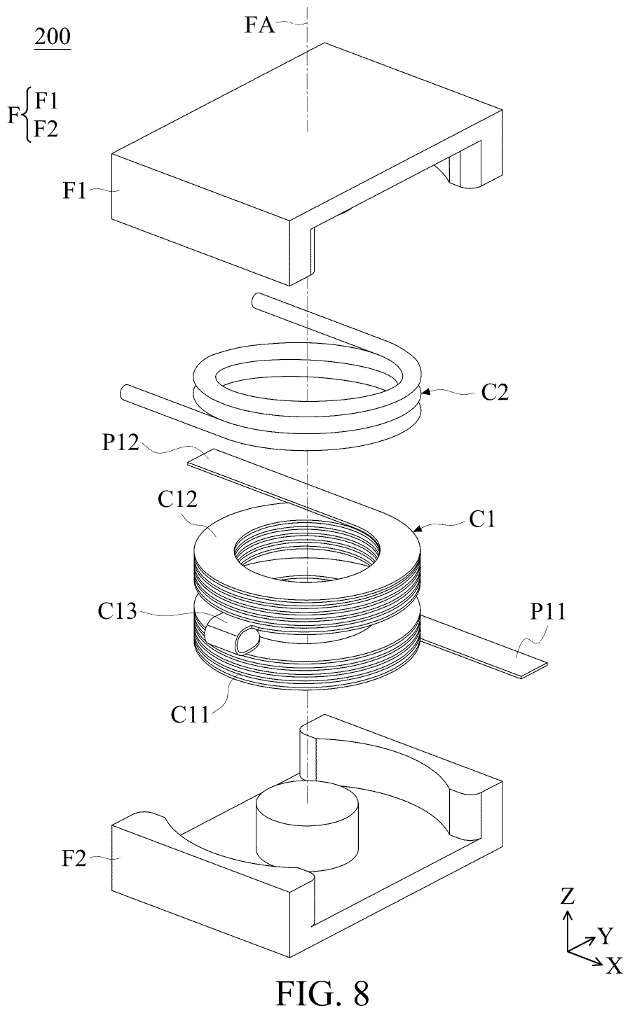

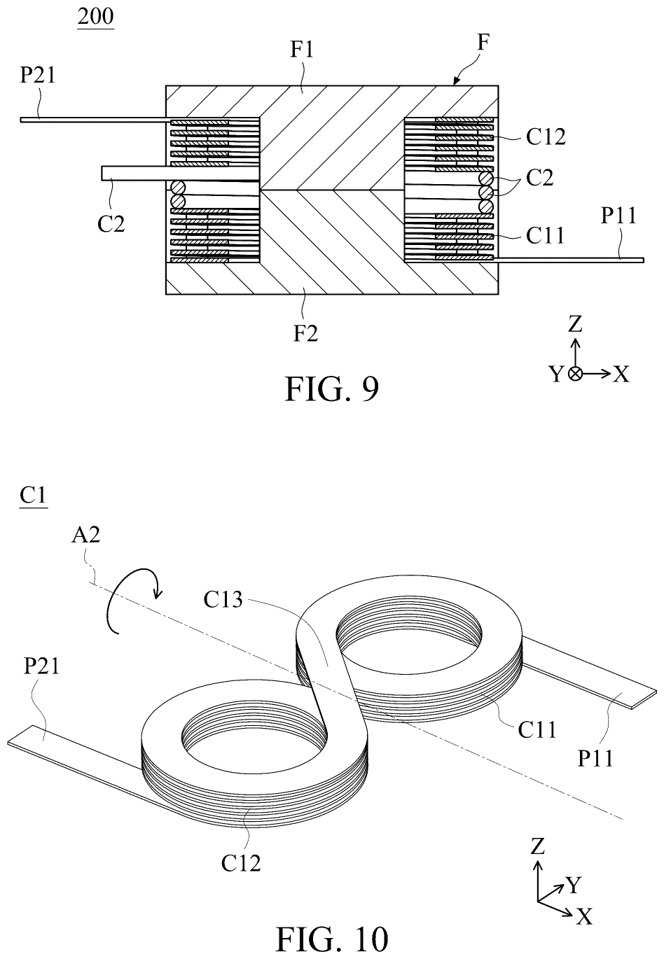

FIG. 7 is a perspective diagram of a transformer structure 200 in accordance with another embodiment of the invention. FIG. 8 is an exploded view of the transformer structure 200 in FIG. 7. FIG. 9 is a cross-sectional view of the transformer structure 200 in FIG. 7.

As shown in FIGS. 7-9, the transformer structure 200 is different from the transformer structure 100 of FIGS. 1-3 in that the first winding C1 of FIGS. 7-9 comprises a flat copper wire, and the second winding C2 comprises a multi-strand wire. Here, the first winding C1 has a first low winding segment C11 and a first high winding segment C12 in a circular shape, and the second winding C2 is sandwiched between the first low winding segment C11 and the first high winding segment C12, thereby forming an interleaved winding structure.

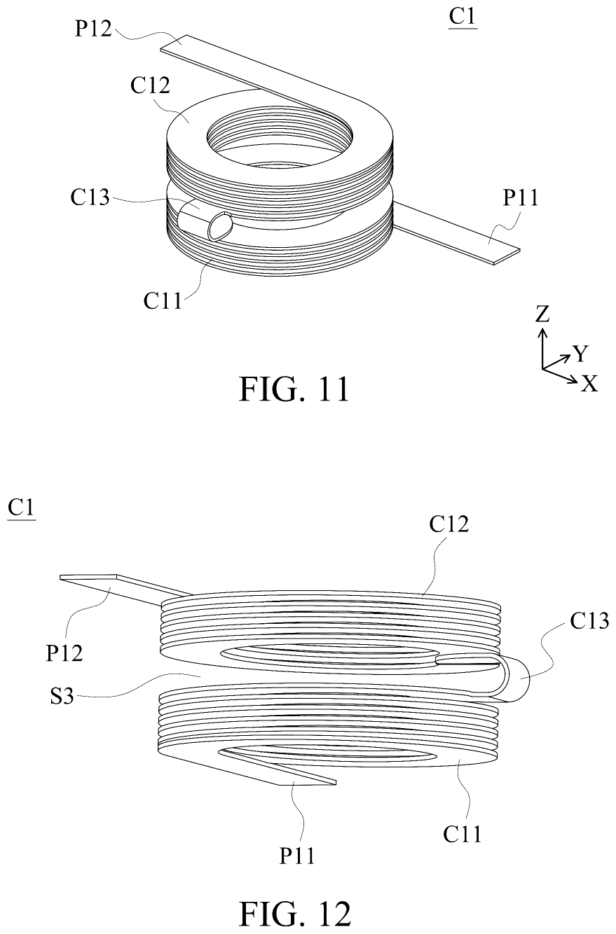

FIG. 10 is a perspective diagram of the first winding C1 in FIGS. 7-9 before forming the C-shaped first connecting portion C13. FIG. 11 is a perspective diagram of the first winding C1 in FIG. 10 after forming the C-shaped first connecting portion C13. FIG. 12 is another perspective diagram of the first winding C1 after forming the C-shaped first connecting portion C13.

As shown in FIG. 10, the first winding C1 comprises a flat copper wire. During assembly, the flat copper wire can be processed by a winding machine to form the first low winding segment C11 and the first high winding segment C12 that have a circular structure. Subsequently, the first connecting portion C13 between the first low winding segment C11 and the first high winding segment C12 can be folded around the horizontal axis A2 as shown in FIG. 10, whereby the first connecting portion C13 forms a C-shaped structure (FIGS. 11 and 12).

In this configuration, the first low winding segment C11 and the first high winding segment C12 are arranged along the central axis FA of the core unit F (FIG. 8), and a gap S3 is formed between the first low winding segment C11 and the first high winding segment C12 (FIG. 12).

Since the first low winding segment C11 and the first high winding segment C12 are connected in series through the C-shaped first connecting portion C13, they can be electrically connected to the external circuit through the first ends P11 and P12 of the first winding C1, thus reducing the number of contacts between the first winding C1 and the substrate (not shown). Hence, assembly cost of the transformer structure 200 can be reduced, and miniaturization of the product can be also achieved.

It should be noted that the second winding C2 in this embodiment comprises a multi-strand wire. During assembly of the transformer structure 200, the second winding C2 is sandwiched between the first low winding segment C11 and the first high winding segment C12 to form the interleaved winding structure. However, the second winding C2 may comprise flat copper wire or other types of windings, and it is not limited to those disclosed in the embodiments of the invention.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification.

As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A transformer structure, comprising:
a core unit, having a central axis;
a first winding, disposed on the core unit and having a first low segment, a first high segment, and a first connecting portion connected between the first low segment and the first high segment, wherein a first gap is formed between the first low segment and the first high segment; and
a second winding, disposed on the core unit and having a second low segment, a second high segment, and a second connecting portion connected between the second low segment and the second high segment, wherein a second gap is formed between the second low segment and the second high segment;
wherein the second low segment is accommodated in the first gap, the first high segment is accommodated in the second gap, and the first low segment, the second low segment, the first high segment, and the second high segment are arranged along the central axis.

2. The transformer structure as claimed in claim 1, wherein the transformer structure is disposed on a substrate, and the first winding further has two first ends extending through the substrate and respectively connecting to the first low segment and the first high segment.

3. The transformer structure as claimed in claim 2, wherein the second winding further has two second ends extending through the substrate and respectively connecting to the second low segment and the second high segment, and the first ends and the second ends are located on opposite sides of the core unit.

4. The transformer structure as claimed in claim 1, wherein the first connecting portion is folded around a horizontal axis that is perpendicular to the central axis.

5. The transformer structure as claimed in claim 1, wherein the first low winding segment, the first high winding segment, the second low winding segment and the second high winding segment have an oval structure, and a part of the core unit extends sequentially through the first low winding segment, the second low winding segment, the first high winding segment and the second high winding segment along the central axis.

6. The transformer structure as claimed in claim 1, wherein the first and second windings respectively comprise a flat copper wire that is integrally formed in one piece.

7. A transformer structure, comprising:
a core unit, having a central axis;
a first winding, disposed on the core unit and having a first low segment, a first high segment, and a first connecting portion connected between the first low segment and the first high segment, wherein a gap is formed between the first low segment and the first high segment; and
a second winding, accommodated in the gap, wherein the first low segment, the second winding, and the first high segment are arranged along the central axis.

8. The transformer structure as claimed in claim 7, wherein the first low winding segment and the first high winding segment have a circular structure, and a part of the core unit extends sequentially through the first low winding segment, the second winding, and the first high winding segment along the central axis.

9. The transformer structure as claimed in claim 7, wherein the first connecting portion has a C-shaped structure, and the first winding comprises a flat copper wire that is integrally formed in one piece.

10. The transformer structure as claimed in claim 7, wherein the second winding comprises a multi-strand wire.
